(19) United States
(12) Patent Application Publication
(10) Pub. No.: US 2002/0113695 A1
(43) Pub. Date: Aug. 22, 2002

(54) Automated remote control system for hotel in-room safes

(76) Inventors: Nick Ernst, Victoria (CA); Ian Soutar, Victoria (CA); Ed Haslam, Victoria (CA)

Correspondence Address: MARSH, FISCHMANN & BREYFOGLE LLP, 3151 SOUTH VAUGHN WAY, SUITE 411, AURORA, CO, 80014, US

(21) Appl. No.: 10/060,017

(22) Filed: Jan. 28, 2002

Related U.S. Application Data
(60) Provisional application No. 60/264,944, filed on Jan. 29, 2001.

(51) Int. Cl. G08B 21/00

(52) U.S. Cl. 340/540; 340/539

(57) ABSTRACT

The present invention provides a system and method for controlling hotel in-room safes. The invention comprises a control computer that controls the operation of each in-room safe by transmitting enable or disable commands over a wireless transmission link to a receiver-controller installed in each safe. The use of the safe is enabled or disabled when a guest calls a predetermined telephone number that is interpreted as a command to enable or disable the in-room safe. Each receiver-controller is battery-powered and a technique is employed by the system to conserve battery power by transmitting commands to safes at a predetermined time. Each safe turns on its wireless receiver only at the predetermined time and turns off its receiver after receiving the command thereby conserving the life of the battery.

### CROSS-REFERENCE TO RELATED APPLICATIONS

This application claims priority under 35 U.S.C. §1.119 to U.S. Provisional Patent Application No. 60/264,944 filed Jan. 29, 2001, the entire contents of which are incorporated herein by reference as if set forth herein in full.

### FIELD OF THE INVENTION

This invention relates to the field of remote control systems for hotel in-room safes.

### BACKGROUND OF THE INVENTION

Many hotel operators view having safes in their rooms for use by their guests as a source of revenue. Several makes and models of in-room safes are available on the market. The majority of these safes are accessed electronically where a guest enters several digits on a keypad on the safe to open or close it. On some models, a swipe card reader is provided to allow the guest to use a credit card as a key for the safe. Accurate and economical tracking of the use of the in-room safes is needed to give the hotel operator the necessary information required to charge the guest a nominal fee for the use of the safe.

One of the problems with a keypad controlled safe is that a guest will set their own passcode for the safe and, upon checking out of the guest room, close the safe and not inform anyone what the passcode is. The next guest using the room is not able to open the safe until the hotel operator opens the safe for the guest. This would require sending a repairman to the guest room and manually resetting and opening the safe. If the hotel is large, the hotel operator could conceivably have a person working full-time simply to reset safes throughout the hotel. This would add significant cost to operating an in-room safe service for the guests.

Another problem associated with current in-room safes is the lack of ability to accurately monitor and control the use of the safes. If a safe was simply left enabled at all times, there would be no way to track the use of the safe and the guest would be able to use the safe without paying for it.

Various attempts have been made to monitor or control the usage of in-room safes. These attempts have utilized the existing cable TV system or an alternate hard-wired cable facility to connect each safe to a central control system. Use of the existing cable TV network is undesirable for a number of reasons. The hotel operator may not own the cable TV network and use of this facility may require a usage fee payable to the cable TV operator that increases the operating cost of the system. Combining the safe control signals with the programming signals from the cable TV operator over the cable TV network may be detrimental to both services as the television signals may interfere with the control signals to the safes while the additional equipment required to superimpose the safe controls signals onto the cable network may degrade the quality of the TV signal sent to the television set. Furthermore, any maintenance performed on the cable TV network by the cable TV operator may interfere or disrupt the control and monitoring of the in-room safes. Alternatively, hard-wired systems to control and monitor the in-room safes are also undesirable as the additional cable and installation costs make the system less economical.

In summary, these prior attempts are uneconomical, cumbersome or lack the necessary accuracy to provide the hotel operator the information required to accurately charge the guest for the use of the in-room safes.

The present invention employs many novel features implemented in hardware and computer software to overcome these obstacles resulting in a very economical system to accurately control and monitor the status and usage of in-room safes.

### SUMMARY OF THE INVENTION

The present invention is an apparatus and method for controlling in-room safes in hotel guest rooms where each safe comprises an electronically controllable lock mechanism.

The present invention is a Remote Control System (“RCS”) that comprises a number of components that work together to monitor and control the use of in-room safes by hotel guests. A control computer (“CC”) is used to control and monitor the operation of the in-room safes. The CC interfaces with the hotel telephone system or private branch exchange (“PBX”) and the hotel property management system (“PMS”). The PMS informs the CC when a guest has checked in or out of a guest room having an in-room safe while the CC informs the PMS when a guest is using their in-room safe so that the hotel may properly bill the guest for the use of the safe.

A guest wishing to use, or discontinue to use, their in-room safe simply dials a predetermined telephone number in the hotel's telephone directory through the PBX to connect with the RCS. The RCS interprets the call as a command to enable or disable the guest's in-room safe. The PBX also provides the CC the room number of the guest so that the CC will know which in-room safe to enable or de-enable. Upon receiving a command to enable or disable the safe, the CC also informs the PMS of this for billing purposes. Alternatively, the telephone command is forwarded from the PBX to the PMS which, in turns, informs the CC to enable or disable the safe. How this is performed depends on the capabilities and features of the PBX and PMS installed at the hotel. The present invention is adaptable to operate with the various types of PBX and PMS systems.

A guest may also enable or disable their in-room safe when they check in at the hotel or at some other time during their stay at the hotel by making the request at the front desk. This request is entered into the PMS and the PMS submits the command to enable or disable the safe to the CC. The PMS is informed of the guest's usage of the safe for billing purposes.

Once the CC has received a request to enable or disable an in-room safe, the CC assembles an instruction that comprises the unique identification number of the safe and the command to enable or disable the safe. The instruction is forwarded to a transmit control module (“TCM”) to be inserted into a data packet that includes a preamble comprising timing and synchronization signals required by the system to operate. The TCM conditions the data packet into a data stream that can modulate a radio carrier signal. The modulated radio signal is then amplified and transmitted by a wireless radio transmitter (“RT”) to radiate throughout the hotel from an antenna.

Each in-room safe is equipped with a safe control module (“SCM”). Each SCM comprises a wireless radio receiver (“RR”) and a receiver-controller (“RC”). The RR receives the radio signal transmitted by the RT and demodulates the data stream from the radio signal. The RC in each in-room safe is programmed with a unique identification number assigned to it by the CC thereby giving each in-room safe its own unique identifier.

The RC will receive all instructions transmitted by the RT. When an RC receives a instruction that contains the unique identifier of its safe, the RC will then enable or disable the safe in accordance with the command contained in the instruction by enabling or disabling the lock mechanism of the safe.

The RC in every in-room safe is battery powered so that each safe is completely self-contained and freestanding. This allows the safe to be installed in a convenient location anywhere in the guest room and not be dependent on AC power. To conserve energy and to extend the life of the battery in each safe, the system employs a novel technique to limit the power consumption of the SCM in each safe.

All of the safes in the hotel are organized into logical groups such as, for example, all of the safes on a particular floor or group of floors in the hotel. The RCS organizes the instructions to be transmitted to the safes by assembling and transmitting a queue of instructions to the safes one group at a time. When the RCS has finished transmitting instructions to one group, it then assembles a queue of instructions for transmission to the next group. The RCS continues with this progression of transmitting instructions to successive groups of safes in a predetermined fashion until it has transmitted instructions to all of the safes. At precise times, the RCS repeats this cycle.

The RC in each safe synchronizes its internal clock from the preamble contained in the data stream transmitted by the RCS. The preamble also informs each RC of the next time to turn on its respective RR so the RC will know when to turn on its RR again to receive the set of instructions transmitted from the RCS during its next cycle. Once the RCS has completed transmitting instructions to a group of safes, the RC in each safe of the group turns off the power to its RR and waits until the next scheduled transmission time. In doing this, each RC causes its RR to be in an “off” state for most of the time thereby conserving the power drawn from its battery.

Broadly stated, the present invention is a system and method for controlling a plurality of secure containers, each having a controllable lock mechanism, the system comprising means for inputting a command to enable or disable a particular container; a control computer for assembling an instruction operative to enable or disable the particular container in response to the command, the instruction comprising an identifier specific to the particular container; transmitting means, operatively connected to the control computer, for conditioning the instruction for wireless transmission and wirelessly transmitting the conditioned instruction to the containers; and each container comprising container control means for receiving the transmitted instruction and for enabling or disabling the lock mechanism of that container if the instruction contains the identifier specific to that container.

### DESCRIPTION OF THE DRAWINGS

FIG. 1 is an overall functional block diagram of the present invention;

FIG. 2 is a functional block diagram of the safe control module of the present invention;

FIG. 3 is a flowchart diagram illustrating the steps of the Front Desk Safe Activation/Deactivation Request process of the present invention;

FIG. 4 is a flowchart diagram illustrating the steps of the Safe Activation process of the present invention;

FIG. 5 is a flowchart diagram illustrating the steps of the Secure Forced Opening of a Safe process of the present invention;

FIG. 6 is an electrical schematic of the Transmit Control Module circuit of the present invention;

FIG. 7 is a functional block diagram of the Radio Transmitter of the present invention;

FIG. 8 is an electrical schematic of the Receiver Controller circuit of the present invention;

FIG. 9 is a flowchart diagram illustrating the steps of the Receiver Controller firmware of the present invention; and

FIG. 10 is a flowchart diagram illustrating the steps of the Full Building Scan process of the present invention.

### DETAILED DESCRIPTION OF THE PREFERRED EMBODIMENT

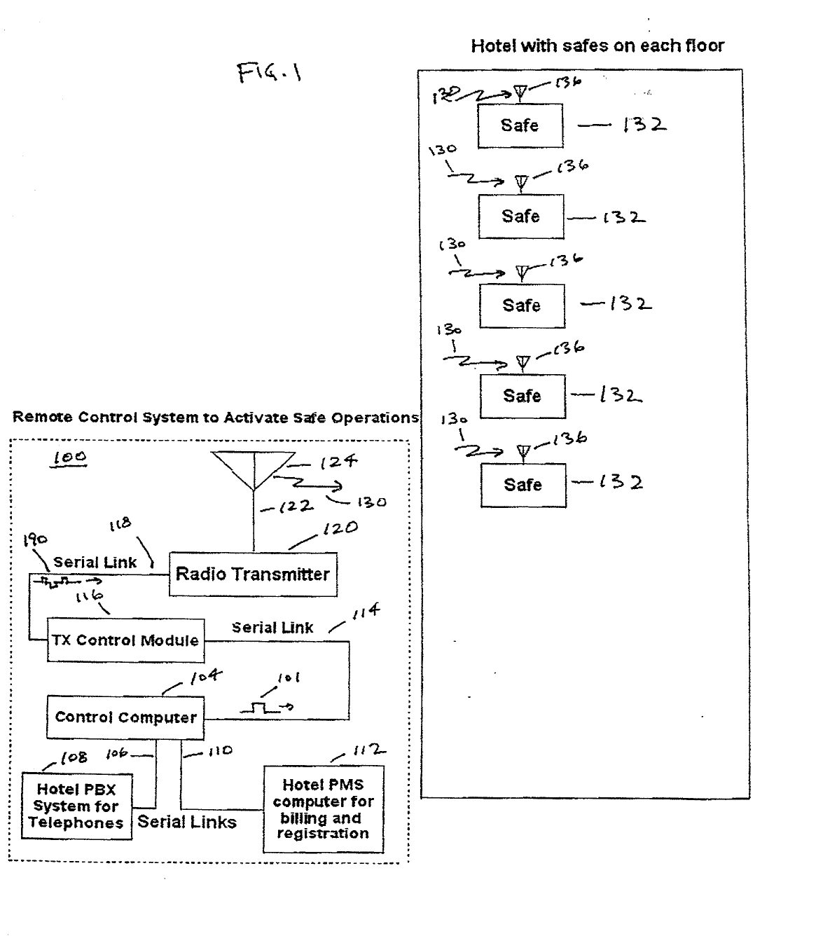

FIG. 1 illustrates the functional elements of the present invention. Remote Control System (“RCS”) 100 comprises control computer (“CC”) 104, transmit control module (“TCM”) 116, radio transmitter (“RT”) 120 and antenna 124. CC 104 communicates with the hotel telephone system or private branch exchange (“PBX”) 108 over cable 106. CC 104 also communicates with the hotel property management system (“PMS”) 112 over cable 110.

CC 104 is a general purpose computer capable of operating the RCS control and database management software and comprises at least three serial data communications ports. Almost any type of general purpose computer running an operating system such as DOS, Windows or Linux may be used as the RCS software can be adapted to run on these operating systems.

RCS 100 comprises software that permits RCS 100 to receive commands to enable or disable a particular safe, assemble the instruction to enable or disable the particular safe in response to the command and then transmit the instruction to the particular safe.

Within hotel 128, there is a safe 132 installed in each guest room that can be enabled or disable by RCS 100. Each safe 132 may be any commercially available safe that comprises a keypad and an electronically controllable lock mechanism. Safe 132 may also comprise a swipe card reader that allows the use of credit cards as “keys” to open or close the safe. Contained in each safe 132 is a safe control module (“SCM”) 134 that is controllable by RCS 100. Each safe 132 is assigned a unique identification number or identifier by RCS 100 when the safe is first installed and initialized to operate with RCS 100.

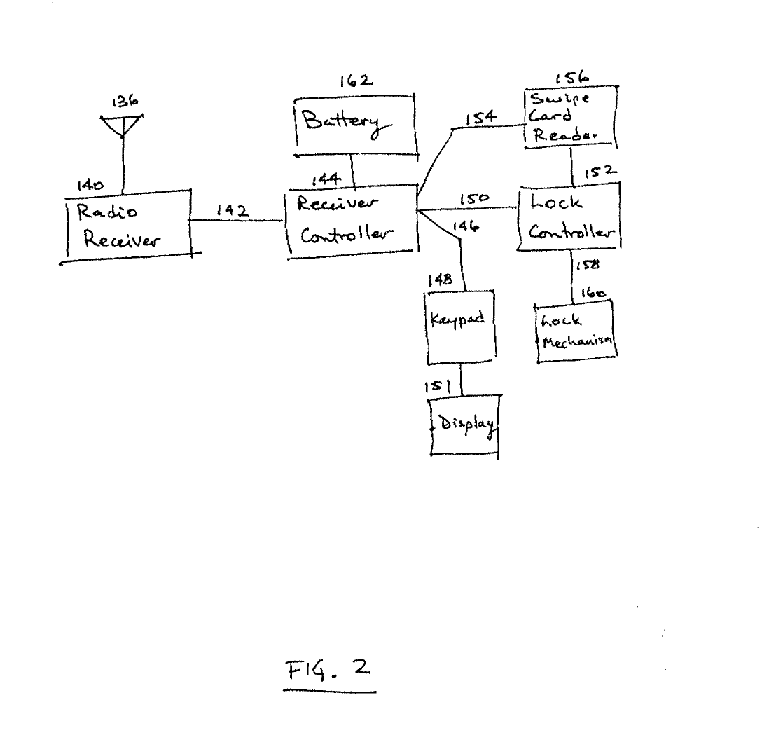

Shown in FIG. 2 are the functional elements of SCM 134. SCM 134 comprises radio receiver (“RR”) 140, antenna 136 mounted on RR 140, receiver-controller (“RC”) 142 and battery 162. Cable 142 connects RR 140 to RC 144. Battery 162 provides DC power for both RC 144 and RR 140. Cable 148 connects RC 144 to keypad 148 which comprises display 151. Cable 150 connects RC 144 to lock controller 152. Cable 158 connects lock controller 152 to lock mechanism 160.

For a guest to enable or disable safe 132 in their room in hotel 128, there is more than one way that this may be accomplished. One method is performed by the guest making a request at the front desk of hotel 128 to enable or disable the safe in their room.

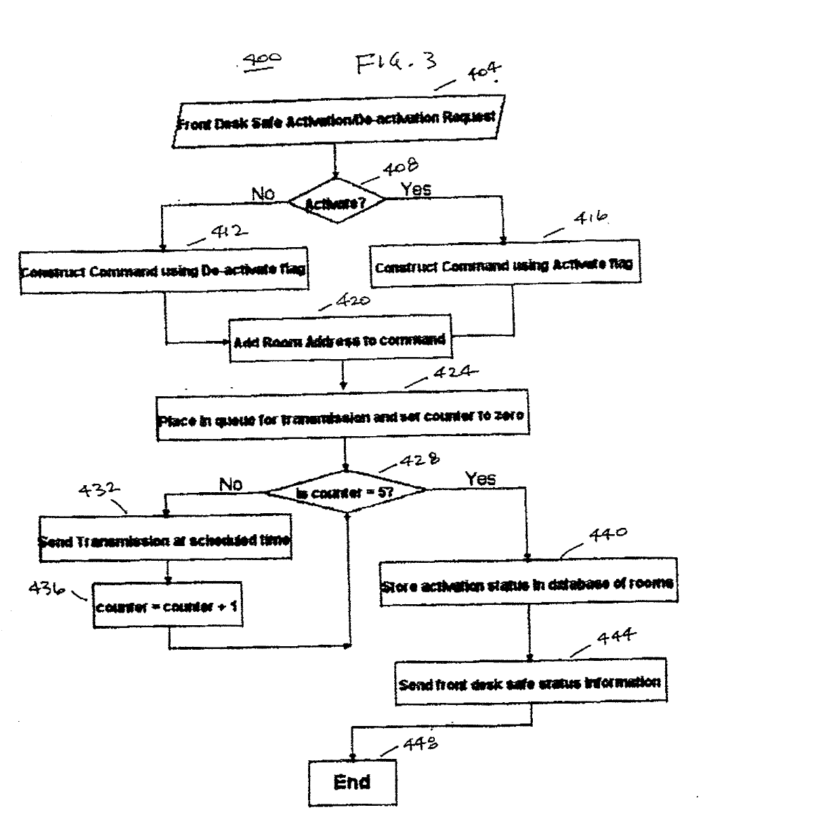

FIG. 3 illustrates the functional steps of front desk activation process 400 followed by RCS 100. The guest is queried at step 404 if they want to use the safe in their room. Their response is entered into PMS 112. Step 408 determines which steps are to be followed if the guest's response is “yes” or “no”. If the guests wants the safe disabled, PMS 112 instructs RCS 100 at step 412 to assemble a disable command. If the guest wants the safe enabled, PMS 112 instructs RCS 100 at step 416 to assemble an enable command. Both steps 412 and 416 lead to step 420 where PMS 112 informs RCS 100 of the room number of the safe to be enabled or disabled so that a instruction for safe 132 can be assembled. At step 424, RCS 100 puts the instruction into a queue of instructions that is transmitted as an RS-232 serial data signal 101 to TCM 116 over cable 114 to be transmitted by RT 120. RCS 100 follows steps 428, 432 and 436 to transmit the queue of instructions five times to the safes.

The purpose of RCS 100 for repeating the transmission is to ensure that each safe 132 has received at least one transmission of the instructions. Radio frequency noise and radio signals from other sources may interfere with the transmission from RT 120, therefore, the transmission of the instructions is repeated to ensure that each safe 132 receives the transmission. The number of times the instructions are transmitted does not necessarily have to be five so long as the number chosen provides sufficient probability that each safe 132 will receive at least one transmission of the instructions. Once the instructions have been transmitted, RCS 100 stores the activation status of safe 132 in the RCS database at step 440. RCS 100 then informs RMS 112 of the status of safe 132 for the guest's billing records at step 444 whereupon the process ends at step 448.

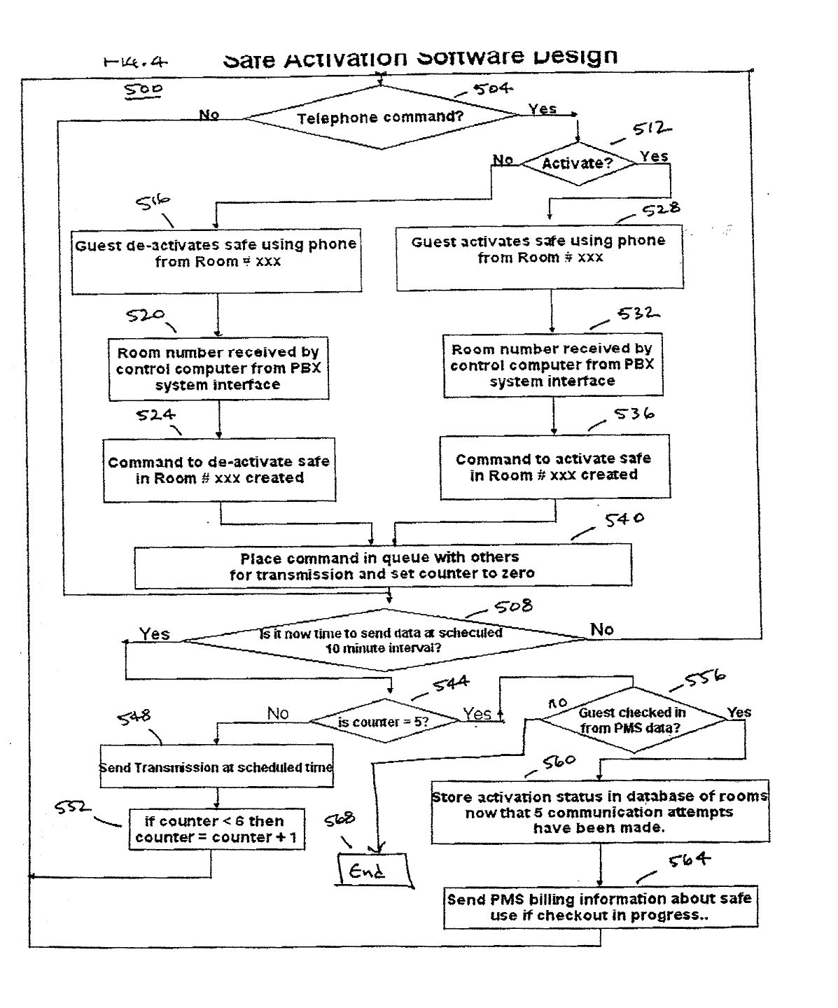

The other way a guest may enable or disable safe 132 is by using the telephone in their room. FIG. 4 illustrates the functional steps of safe activation process 500 followed by RCS 100 when a guests uses their in-room telephone to enable or disable safe 132. The entering of the command to RCS 100 using the telephone system in hotel 128 can be accomplished in a number of ways depending on the capabilities and features of PBX 108 and PMS 112. One method is to dial a single predetermined telephone number programmed in PBX 108 from the telephone in the room housing safe 132 whereupon a voice announcement prompt programmed in PBX 108 instructs the guest to enter one digit to enable safe 132 or to enter another digit to disable safe 132. The digit entered by the guest is interpreted by CC 104 as an enable or disable command.

Another method is to program one telephone number in PBX 108 that corresponds to enabling safe 132 and programming a second telephone number that corresponds to disabling safe 132. PBX 108 forwards this information to CC 104 over cable 106. PBX 108 also forwards the room number of the guest entering the command to CC 104. CC 104 uses this information to derive the unique identifier of safe 132 and to assemble the instruction that comprises the unique identifier of safe 132 and the command to enable or disable the safe.

Yet another method of enabling or disabling safe 132 using the telephone in the room housing safe 132 is to program one or two telephone numbers in PBX 108, as discussed above, for enabling or disabling safe 132 but PBX 108 forwards the command and room number of safe 132 to PMS 112 which, in turn, forwards this information to CC 104 over cable 110. Whichever method is implemented will depend entirely on the capabilities and features of PBX 108 and PMS 112 installed in hotel 128. RCS 100 is adaptable to accommodate any of these methods.

Referring to the process illustrated in FIG. 4, RCS 100 queries whether a telephone command is present at step 504. If a telephone command is present, RCS 100 then queries at step 512 whether the command is to enable or disable safe 132. If a disable command is entered, RCS 100 assembles a disable instruction at step 516. RCS 100 receives the room number of safe 132 from PBX 108 at step 520 and then derives the unique identifier of safe 132 and assembles the instruction to disable safe 132 at step 524. If an enable command is entered, RCS 100 assembles an enable command at step 528. RCS 100 receives the room number of safe 132 from PBX 108 at step 528 and then derives the unique identifier of safe 132 and assembles the instruction to enable safe 132 at step 536.

At step 540, RCS 100 places the instruction into a queue of instructions that is transmitted as an RS-232 serial data signal 101 to TCM 116 for transmission to all safes 132 in hotel 128. RCS 100 then queries at step 508 whether it is time to transmit the instructions. If not, RCS 100 reverts back to step 504 to look for any other telephone commands to include in the queue of instructions to be transmitted. If it is time to transmit the instructions, RCS 100 follows steps 544, 548 and 552 until the queue of instructions have been transmitted to safes 132 five times. As discussed above with activation process 400, the number of times the queue of instructions are transmitted does not necessarily need to be five so long as the instructions have been transmitted a sufficient number of times to ensure that there is a good probability that all of the safes will receive at least one complete transmission. Once the instructions have been transmitted, RCS 100 queries PMS 112 at step 556 whether the guest entering the command has checked in. If “yes”, RCS 100 stores the activation status of safe 132 in the RCS database at step 560. RCS 100 then informs PMS 112 the activation status of safe 132 at step 564. RCS 100 reverts to step 504 to check if a telephone command is present. If, at step 556, the guest has not checked in, RCS 100 terminates safe activation process 500 at step 568.

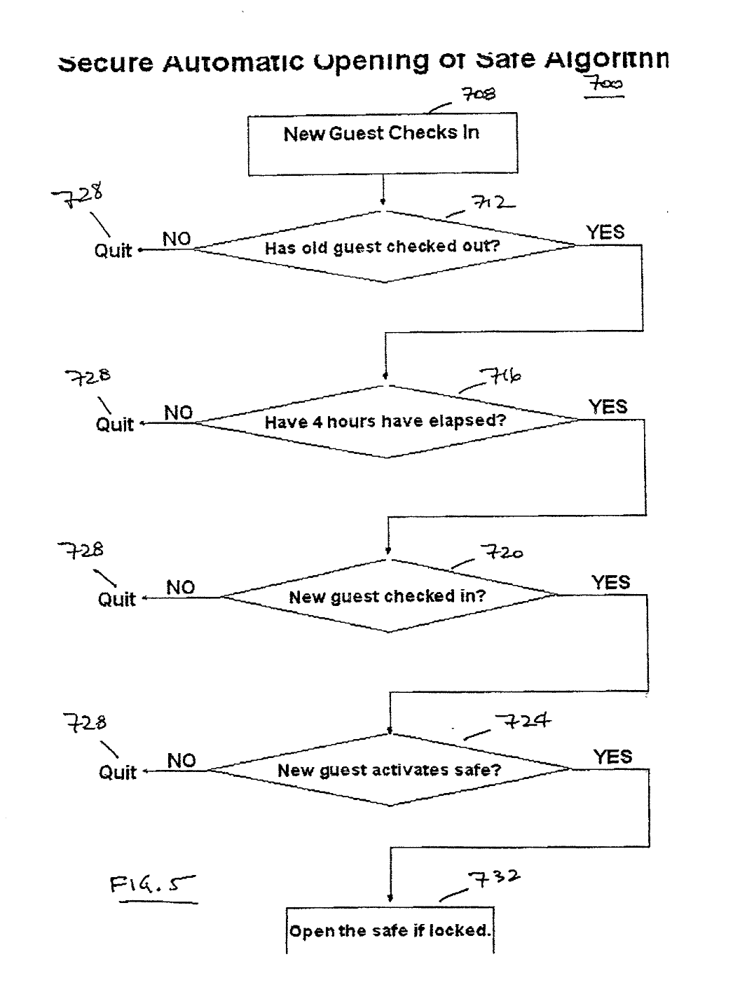

There are occasions where a guest will close and lock their safe before checking out of their room and not inform anyone what passcode they entered into the safe to open or close the safe. The next guest who attempts to open the safe will not be to because they do not have the passcode set by the previous guest. To remedy this situation, RCS 100 will follow the steps set out in safe opening process 700 which is illustrated in FIG. 5. When a new guest checks into the hotel at step 708, RCS 100 verifies that the previous guest for the room has checked out at step 712. If the previous guest has not yet checked out, the process terminates at step 728. If the previous guest has checked out, RCS 100 queries at step 716 if four hours has elapsed since the previous guest has checked out. This time period is adjustable to match the time period between the checkout time and check-in time of hotel 128. If four hours have not elapsed, the process terminates at step 728. If four hours have elapsed, RCS 100 verifies at step 720 that the new guest has checked in. If “no”, the process terminates at step 728. If the new guest has checked in, RCS 100 opens safe 132 in the guest's room at step 732 by submitting an instruction to open safe 132 to the queue of instructions that are transmitted to safes 132 at step 424 of activation process 400.

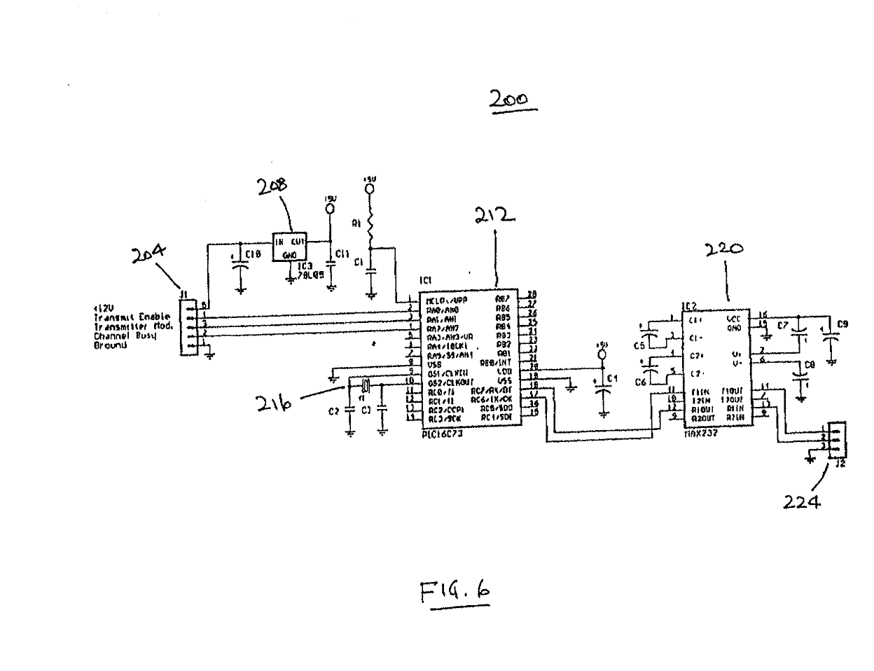

The instructions to be transmitted by RCS 100 are first conditioned for transmission by TCM 116. Shown in FIG. 6 is the electrical schematic of circuit board 200 mounted in TCM 116. Data signal 101 from CC 104 enters buffer 220 on circuit board 200 through connector 224. Buffer 220 converts data signal 101 from RS-232 format to a non-return to zero (“NRZ”) data format. In the present invention, buffer 220 is a dual RS-232 driver-receiver, model MAX232CPE, made by Maxim Semiconductor although any similar featured device will work. Microcontroller 212 receives buffered data signal 101 and conditions it for modulating a radio frequency (“RF”) carrier signal. In the present invention, microcontroller 212 is model PIC16C73-04/P microcontroller made by Microchip Technologies Inc. Crystal 216 is a 3.6864 MHz crystal from CTS Reeves that provides the instruction cycle clock reference for microcontroller 212.

Regulator 208 on circuit board 200 is a generic +5 VDC voltage regulator, available from multiple manufacturers, that regulates the unregulated +12 VDC power from RT 120 to produce the +5 VDC power required by buffer 220 and microcontroller 212.

After converting data signal 101 to NRZ format, microcontroller 212 takes data signal 101 and puts it into a data packet that includes a preamble comprising timing and synchronization data. Microcontroller 212 then creates a data frame which includes five copies of the data packet such that the data packet is transmitted to safes 132 fives times as required by steps 428, 432 and 436 in activation process 400 and steps 544, 548 and 552 in activation process 500.

To condition the data frame for modulating a radio carrier signal, the data frame is Manchester encoded to produce data stream 190 that has no DC voltage component and has a 50% duty cycle. Other standards of data encoding may be used depending on the modulation/demodulation requirements of the radio transceiver used in RT 120 and the radio receiver used in SCM 134. Data stream 190 is then forwarded to RT 120 over cable 118.

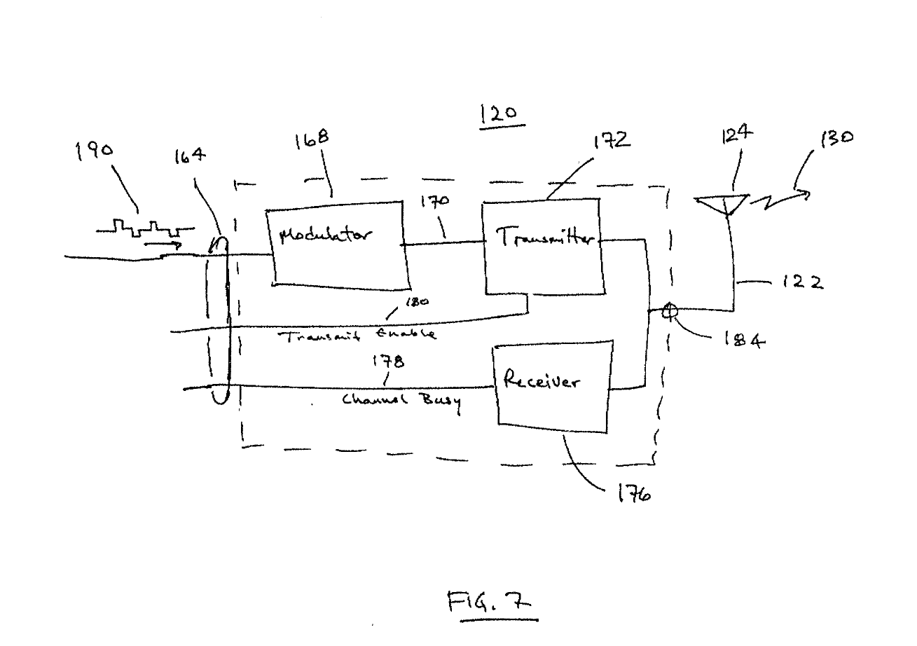

The functional elements of RT 120 are shown in FIG. 7. In the experiments that were conducted in the development of the present invention, it was found that the radio frequency that provided good performance in radiating throughout the physical structure of a hotel and being received by safes in the hotel rooms was an ultra-high frequency (“UHF”) in the range of 450 Megahertz to 470 Megahertz. It was also found that an output power of five to thirty watts was required at these frequencies in order to make the radio transmission link work between RT 120 and safes 132.

In the present invention, RT 120 is a commercially available UHF transceiver that comprises a direct data input and a user-selectable output power. In the preferred embodiment, RT 120 is a Kenwood UHF transceiver, model TK-860. It is a “push to talk” transceiver that requires an input command to transmit and also comprises a receiver to detect any other radio signals in the radio channel used by the transceiver. The device produces a “channel busy” signal to provide a controller information on whether the radio channel is available for transmission.

In the present invention, RT 120 receives data stream 190 from TCM 116 over cable 118 and through connector 164 where it is modulated onto an intermediate frequency (“IF”) carrier 170 at modulator 168. IF carrier 170 is modulated onto a radio frequency (“RF”) carrier and is amplified at transmitter 172 to produce radio signal 130. Radio signal 130 is connected to antenna 124 through coax cable 122 where it radiates throughout hotel 128. Antenna 124 may be an omni-directional or a unidirectional UHF antenna depending on the location of antenna 124 within hotel 128 and area of coverage that antenna 124 must provide to reach all safes 132 in hotel 128. A Sinclair Labs model 30B quarter-wave omni-directional vertical antenna has been used successfully with the present invention.

In order for RT 120 to transmit radio signal 130, transmit enable lead 180 must be enabled by TCM 116. Before radio signal 130 is transmitted, TCM 116 requires feedback from receiver 176 whether the radio channel is clear. Receiver 176 detects any other radio signals in the radio channel and controls channel busy lead 178. If other UHF radio signals are present, receiver 176 enables channel busy lead 178 which is fed back to TCM 116. This signals microcontroller 212 that radio transmission cannot take place until the radio channel is clear. Microcontroller 212 also informs CC 104 that the attempt to transmit data stream 190 was aborted. When receiver 176 detects no other radio signals, channel busy lead 178 is disabled and microcontroller 212 is informed that RT 120 can transmit radio signal 130. Microcontroller 212 will enable transmit enable lead 180 and will transmit data stream 190 to RT 120 to be transmitted. After data stream 190 has been transmitted, transmit enable lead 180 is disabled and CC 104 is informed that data stream 190 has been transmitted. The data rate of data stream 190 that is currently being transmitted by the present invention is 600 Baud. This is limited by the data transmission capacity of the transceiver device used in RT 120. If the cost of the electronic components were not a factor in producing the present invention, higher data rates could be achieved using other higher performance radio transceiver components of a higher cost.

Radio signal 130 transmitted by RT 120 is received by SCM 134 in each safe 132 located in hotel 128. Antenna 136 on RR 140 detects radio signal 130. RR 140 demodulates data stream 190 from radio signal 130. In the present invention, RR 140 is a commercially available pager receiver circuit that has a data output. Possible examples of acceptable devices for this application are a dedicated remote control type receiver as manufactured by Ming Microsystems or a personal paging receiver board such as used in Motorola Keynote pagers. In the preferred embodiment of the present invention, a Motorola Bravo pager receiver board, model AARE4001A-0, is used as RR 140. This device provides good performance at a low cost.

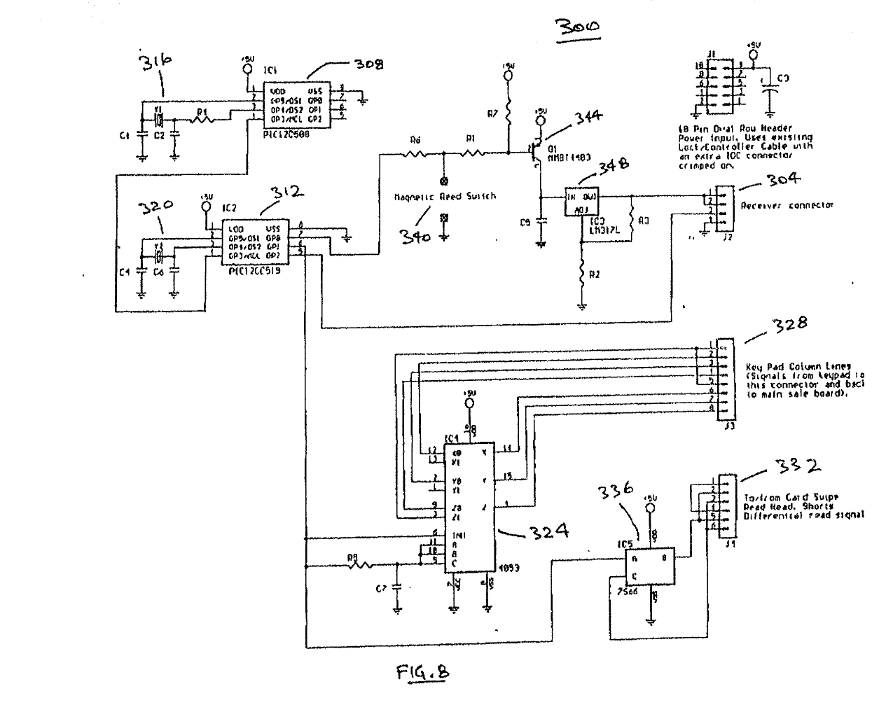

After being demodulated by RR 140, data stream 190 is transmitted to RC 144 over cable 142. FIG. 8 illustrates the electrical schematic of circuit board 300 of RC 144. There are two microcontrollers on circuit board 300. Microcontroller 308 is a model PIC12C508-04/SO microcontroller manufactured by Microchip Technology Inc. and generates internal timing clock signal 310 that has a frequency of one hertz and generates a leading edge clock pulse every second. Crystal 316 is a 32.768 kilohertz watch-type crystal that provides the timing reference for microcontroller 308 to produce clock signal 310. Microcontroller 312 is a model PIC12CE518-04/SO microcontroller manufactured by Microchip Technology Inc. and controls all of the functions RC 144. Crystal 320 is 3.6864 megahertz crystal and provides the instruction cycle clock for microcontroller 312.

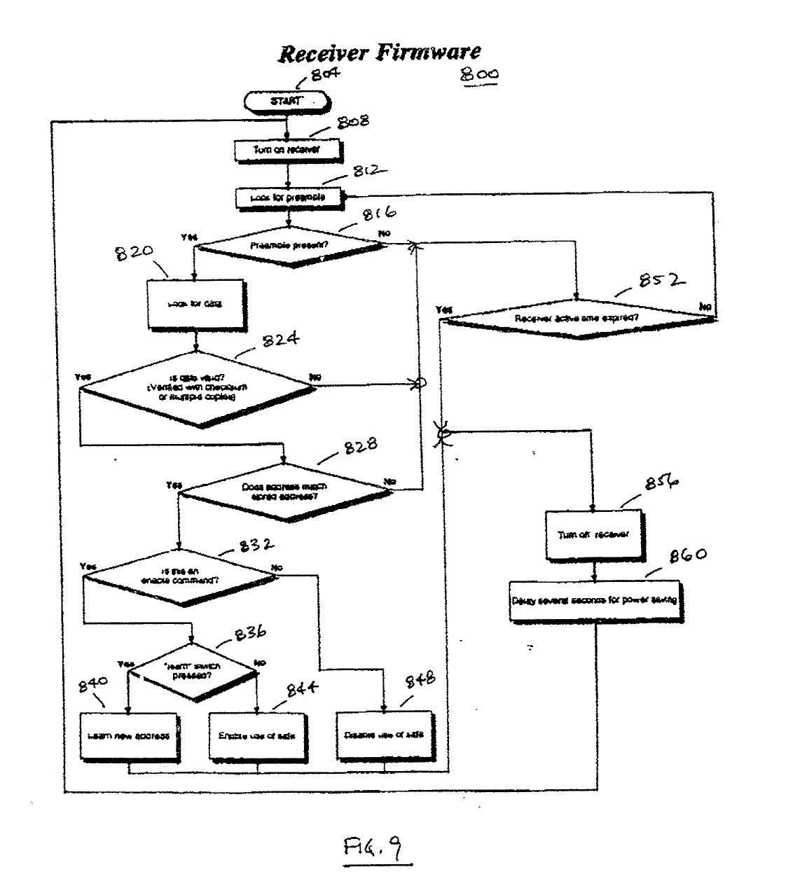

The flowchart of the firmware programmed into microcontroller 312 is shown in FIG. 9. The receiver firmware 800 initially starts at step 804 when SCM 134 is first powered up. At step 808, RC 144 turns on the power to RR 140. At step 812, RC 144 looks for the preamble and any instructions in data stream 190 transmitted by RCS 100. At step 816, RC 144 looks for the preamble in the data packets contained in data stream 190. If the preamble is not present, RC 144 determines at step 852 if the receiver active time for RR 140 has expired. If it has not, RC 144 reverts back to step 812 to look for the preamble again. If the receiver active time has expired, RC 144 proceeds to step 856 to power off RR 140. RC 144 then waits at step 860 before reverting back to step 808 to start the process again.

If RC 144 finds the preamble in data packets in data stream 190, RC 144 then looks for data present in the instructions at step 820. RC 144 examines the data at step 824 to determine if the data is valid. If the data is not valid, then the process reverts back to step 852. If the data is valid, RC 144 determines at step 828 if the instruction contains its unique identifier. If not, the process reverts back to step 852. If the instruction does contain the unique identifier stored in the non-volatile memory of microcontroller 312, then RC 144 determines if the command is an enable command at step 832. If it is not an enable command, RC 144 disables the use of safe 132 at step 848 and then proceeds to step 856 to turn off RR 140. If the command is an enable command, RC 144 checks if switch 340 is turned on at step 836. If switch 340 is activated, RC 144 receives a new unique identifier assigned to it by RCS 100. If switch 840 is not activated, then RC 144 enables safe 132 at step 844. Following steps 840 and 844, RC 144 proceeds to step 856 to turn off RR 140, at which point the RC 144 returns to step 808 and to repeat the process.

Referring back to FIG. 8, microcontroller 312 primarily operates in a shutdown mode to minimize power consumed from battery 162. When microcontroller 312 receives a leading edge clock pulse from clock signal 310, microcontroller 312 reverts to normal operation and turns on power to RR 140 by turning on transistor 344. Regulator 348 is a standard LM 317 regulator and regulates the voltage supplied to it by transistor 344. Resistors 345 and 347 adjust the output voltage from regulator 348 to the +1.5 VDC required by RR 140 which is fed to it over cable 142. Microcontroller 312 waits for a sufficient amount of time to allow RR 140 to stabilize and then begins to look for data stream 190 from RR 140. Microcontroller 312 analyzes data stream 190 for the timing and synchronization data inserted into the preamble of the data packets contained in data stream 190. If the preamble is not present, microcontroller 312 rejects the received data stream 190 as RF noise or as an interfering transmission from another source and shuts down until it receives the next timing pulse on clock signal 310. If the preamble is present in data stream 190, microcontroller 312 converts data stream 190 into data signal 101 and then extracts the unique identifiers and commands contained in data signal 101. In each SCM 134, the unique identifier of each safe 132 is programmed into the non-volatile memory of microcontroller 312. No two safes will have the same unique identifier.

If the unique identifier extracted from data signal 101 by microcontroller 312 does match the unique identifier of safe 132, microcontroller 312 then determines if the command is to enable or disable safe 132. If the command is to enable safe 132, microcontroller 312 checks the status of magnetic switch 340 to determine if safe 132 is being initialized. When each safe 132 is first installed, it contains a default identifier and must be initialized by RCS 100 to receive a unique identifier to operate in the system. When safe 132 is being initialized, it is configured into a learn mode by activating switch 340. To activate switch 340, a magnet is placed on the safe control bezel behind which switch 340 is located. If microcontroller 312 detects that switch 340 is enabled, microcontroller 312 enters into learn mode and waits to receive the unique identifier assigned and transmitted to it by RCS 100. RCS 100 then transmits the default identifier to safe 132 so that safe 132 will recognize initialization commands and receive its new unique identifier from RCS 100.

If switch 340 is not enabled, microcontroller 312 recognizes that it is not in learn mode and will enable safe 132. If the received command was to disable safe 132, microcontroller 312 will simply disable safe 132. Microcontroller 312 enables or disables safe 132 by enabling or disabling lock controller (“LC”) 152. LC 152 is controlled by intercepting the control signals that normally pass between keypad 148 and LC 152. The control signals from keypad 148 are routed from cable 146 through connector 328 on RC 144 to switch 324. From switch 324, the control signals are routed through connector 328 to LC 152 over cable 150. When microcontroller 312 recognizes the unique identifier in data signal 101, microcontroller 312 activates or deactivates switch 324 to enable or disable the control signals between keypad 148 and LC 152. If safe 132 comprises a swipe card reader (“SCR”) 156, microcontroller 312 will send an activate or deactivate signal to switch 336 which is connected to SCR 156 via connector 332 and cable 154. If the command received by microcontroller is to disable safe 132, switch 336 will shunt or short out the magnetic read head on SCR 156 disabling its ability to read the magnetic stripe on the guest's swipe card. If the command is to enable safe 132, microcontroller 312 signals switch 336 to remove the shunt.

If the unique identifier extracted from data signal 101 does not match the unique identifier of safe 132, microcontroller 312 interprets the commands contained in data signal 101 as being commands for different safes and are ignored. Microcontroller 312 then powers off RR 140 and returns to shutdown mode until the next leading edge timing pulse from clock signal 310.

To conserve battery power consumption in each safe 132, the present invention employs a novel technique in the manner commands are transmitted by RCS 100 to safes 132. In large hotels, the hotel rooms are typically distributed throughout a number of different floors. The present invention is configured, upon its initial installation in a hotel, to organize the safes in the hotel into logical groups. Typically, each logical group will comprise all of the safes on a given floor of the hotel. Accordingly, RCS 100 is programmed to transmit instructions to the safes one logical group at a time.

At precise time intervals, RCS 100 will begin a “scan” of hotel 128 by transmitting instructions to all safes 132 beginning at either the top floor or the bottom floor of hotel 128. The purpose of the scan is to transmit instructions to the safes in a structured and progressive fashion. RCS 100 will begin with a scan, for example, starting on the bottom floor and then progressively move up the hotel one floor at a time. Once RCS 100 scan has reached the top floor, the scan has been completed until the next scheduled time a scan is to be performed. At that time, RCS 100 reverses the direction of the scan by transmitting instruction to safes 132 starting at the top floor and progressively moving down the hotel one floor at a time until the scan reaches the bottom floor of the hotel.

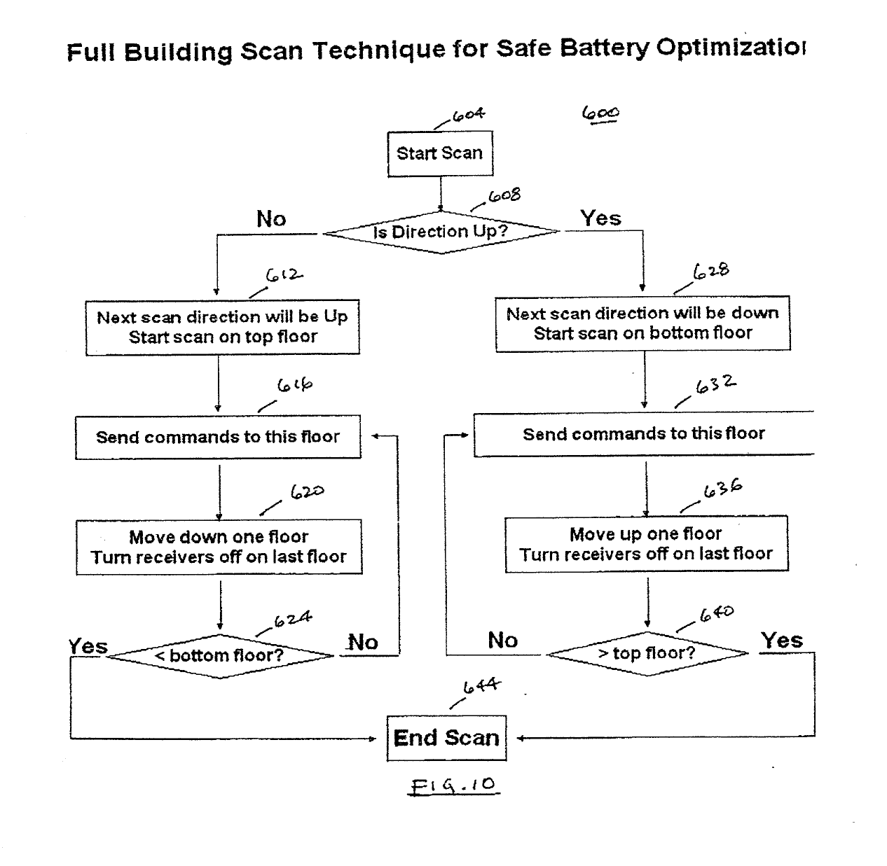

FIG. 10 illustrates the functional steps of the building scan software module 600. RCS 100 initiates a building scan at step 604 at a designated time. At step 608, RCS 100 queries the direction of the scan. If the direction of the current scan is up, step 628 will set a flag that the direction of the next scan will be down. At step 632, RCS 100 sends coded transmissions to the bottom floor. At step 636, RCS 100 increments up one floor to begin transmission of instructions to the safes on this floor. At step 640, if the top floor has not yet been reached, RCS 100 then repeats steps 632 and 636 until all floors have been transmitted to. After reaching the top floor, the scan is terminated at step 644. When the scan is performed at the next designated time, the direction of the scan will be reversed. The scan then goes through steps 612, 616, 620 and 624 to progressively send instructions to groups of safes starting at the top floor and then working down the hotel one floor at a time until the scan has reached the bottom floor. After reaching the bottom floor, the scan is terminated at step 644 until the next designated scan time.

The present invention as disclosed uses UHF radio components due to their low cost and good performance. It is contemplated that other wireless transmission technologies could be adapted to provide similar performance as the UHF radio technology used in the disclosed invention. It is anticipated that magnetic or induction field technology could be used as a wireless communications link between RCS 100 and safes 132. In this adaptation of the present invention, the receiver in the safe could be replaced with a coil, a filtered amplifier, a few passive components and a small power supply. The frequency of the inductive field would in the range of 10 Hertz to 1 Megahertz and would be modulated with on-off keying or other means of modulation to carry data. The desired data rate of communication would determine the frequency of the carrier field. The transmitter would consist of a large coil designed to emit an oscillating magnetic field throughout the hotel. It is also contemplated that other wireless transmission means such as optical or acoustic carrier signals could be used to control safes in hotels as well.

While the present invention was intended to control in-room safes in a hotel, it is also contemplated that the technology could be adapted to other applications. The system could be configured to control lockers in public locker rooms at swimming pools or other athletic or public facilities. The system could also be adapted to control a plurality of secured storage rooms in a public self-storage facility. The technology of the disclosed invention may be adapted for any application where remote control of a number of secured containers, each having a controllable lock mechanism, is required.

We claim:

1. A remote control system for controlling a plurality of secure containers, each having a controllable lock mechanism, the system comprising:
a) means for inputting a command to enable or disable a particular container;
b) a control computer for assembling an instruction operative to enable or disable the particular container in response to the command, the instruction comprising an identifier specific to the particular container;
c) transmitting means, operatively connected to the control computer, for conditioning the instruction for wireless transmission and wirelessly transmitting the conditioned instruction to the containers; and
d) each container comprising container control means for receiving the transmitted instruction and for enabling or disabling the lock mechanism of that container if the instruction contains the identifier specific to that container.

2. The control system as set forth in claim 1 wherein the transmitting means comprises a radio transmitter for modulating the conditioned instruction onto a radio signal and for transmitting the modulated radio signal to the containers from an antenna.

3. The control system as set forth in claim 2 wherein the frequency of the radio signal is in the range of 450 Megahertz to 470 Megahertz.

4. The control system as set forth in claim 3 wherein the output power of the radio signal radiated from the antenna is in the range of 5 to 30 watts.

5. The control system as set forth in claim 1 wherein the container control means of each container comprises:
a) a wireless receiver operative for receiving the wirelessly transmitted instruction; and
b) means for interpreting the instruction as a command to enable or disable the container.

6. The control system as set forth in claim 5 wherein the wireless receiver is a radio receiver operative to receive radio signals in the frequency range of 450 Megahertz to 470 Megahertz.

7. The control system as set forth in claim 5 wherein the means for interpreting a received instruction comprises a receiver controller, operatively connected to the wireless receiver, for reading the command contained in the instruction and for enabling or disabling the lock mechanism of the container if the instruction contains the identifier specific to that container.

8. The control system as set forth in claim 5 wherein each container control means is powered by a battery.

9. The control system as set forth in claim 8 wherein;
a) the transmitting means is adapted to transmit the instruction to enable or disable the particular container at a predetermined time; and
b) the container control means of the particular container is adapted to activate the wireless receiver of that container approximately at the predetermined time to receive the instruction and to deactivate the wireless receiver after the instruction has been received whereby battery life is conserved.

10. A remote control system for controlling a plurality of safes, each having a controllable lock mechanism, the system comprising:
a) means for inputting a command to enable or disable a particular safe;
b) a control computer for assembling an instruction operative to enable or disable the particular safe in response to the command, the instruction comprising an identifier specific to the particular safe;
c) transmitting means, operatively connected to the control computer, for conditioning the instruction for wireless transmission and wirelessly transmitting the conditioned instruction to the safes; and
d) each safe comprising safe control means for receiving the transmitted instruction and for enabling or disabling the lock mechanism of that safe if the instruction contains the identifier specific to that safe.

11. The control system as set forth in claim 10 wherein the safes are hotel in-room safes distributed in the rooms of a hotel.

12. The control system as set forth in claim 11 wherein the means for inputting a command to enable or disable a particular safe comprises:
a) a hotel property management system;
b) a first communications link operatively connecting the control computer to the property management system; and
c) means for interpreting a request entered into the property management system as a command to the control computer to enable or disable the particular safe.

13. The control system as set forth in claim 11 wherein the means for inputting a command to enable or disable a particular safe comprises:
a) a telephone in a hotel room operatively connected to the hotel telephone system, the hotel room comprising the particular safe;
b) a first communications link operatively connecting the telephone system to the hotel property management system;
c) a second communications link operatively connecting the control computer to the hotel telephone system
d) a third communications link operatively connecting the property management system to the control computer; and
e) means for interpreting a telephone call made from the hotel room to a predetermined telephone number as a command to enable or disable the particular safe.

14. The control system as set forth in claim 10 wherein the transmitting means comprises a radio transmitter for modulating the conditioned instruction onto a radio signal and for transmitting the modulated radio signal to the safes from an antenna.

15. The control system as set forth in claim 14 wherein the frequency of the radio signal is in the range of 450 Megahertz to 470 Megahertz.

16. The control system as set forth in claim 15 wherein the output power of the radio signal radiated from the antenna is in the range of 5 to 30 watts.

17. The control system as set forth in claim 10 wherein the safe control means of each safe comprises:
c) a wireless receiver operative for receiving the wirelessly transmitted instruction; and
d) means for interpreting the instruction as a command to enable or disable the container.

18. The control system as set forth in claim 17 wherein the wireless receiver is a radio receiver operative to receive radio signals in the frequency range of 450 Megahertz to 470 Megahertz.

19. The control system as set forth in claim 17 wherein the means for interpreting a received instruction comprises a receiver controller, operatively connected to the wireless receiver, for reading the command contained in the instruction and for enabling or disabling the lock mechanism of the safe if the instruction contains the identifier specific to that safe.

20. The control system as set forth in claim 17 wherein each safe control means is powered by a battery.

21. The control system as set forth in claim 20 wherein;
c) the transmitting means is adapted to transmit the instruction to enable or disable the particular safe at a predetermined time; and
d) the safe control means of the particular safe is adapted to activate the wireless receiver of that safe approximately at the predetermined time to receive the instruction and to deactivate the wireless receiver after the instruction has been received whereby battery life is conserved.

22. A method for controlling a plurality of secure containers, each having a controllable lock mechanism, the method comprising the steps of:
a) inputting a command to enable or disable a particular container;
b) assembling an instruction to enable or disable the particular container in response to the command, the instruction comprising an identifier specific to the specific container;
c) conditioning the instruction for wireless transmission and wirelessly transmitting the conditioned instruction to the containers; and
d) receiving the transmitted instruction and enabling or disabling the lock mechanism of the particular container if the instruction contains the identifier specific to that container.

23. The method as set forth in claim 22 wherein the secure containers are hotel in-room safes distributed in the rooms of a hotel.

24. The method as set forth in claim 23 wherein inputting a command to enable or disable a particular safe comprises the steps of:
a) entering a request to enable or disable a particular safe into the hotel property management system;
b) interpreting the entered request as a command to enable or disable the particular safe.

25. The method as set forth in claim 23 wherein inputting a command to enable or disable a particular safe comprises the steps of:
a) dialing a predetermined telephone number from the telephone in the hotel room containing the particular safe; and
b) interpreting the telephone call to the predetermined telephone number as a command to enable or disable the particular safe.

26. The method as set forth in claim 23 wherein assembling the instruction to enable or disable the particular safe comprises the steps of:
a) receiving the command to enable or disable the particular safe;
b) receiving the room number of the hotel room containing the particular safe;
c) deriving the identifier of the particular safe from the received room number; and
d) combining the identifier and the command into the instruction.

27. The method as set forth in claim 23 wherein transmitting the instruction to the safes comprises the steps of:
a) conditioning the instruction for modulating a radio signal having a frequency in the range of 450 Megahertz to 470 Megahertz; and
b) transmitting the modulated radio signal to the safes from an antenna, the transmitted radio signal having an output power in the range of 5 to 30 watts.

28. The method as set forth in claim 27 wherein enabling or disabling the particular safe comprises the steps of:
a) receiving the transmitted radio signal;
b) demodulating the instruction from the radio signal
c) reading the command contained in the instruction; and
d) enabling or disabling the lock mechanism of the particular safe if the instruction contains the identifier specific to that safe.

29. A method for controlling a plurality of secure containers, each having a lock mechanism controlled by a battery-powered control means, the method comprising the steps of:
a) inputting a command to enable or disable a particular container;
b) assembling an instruction to enable or disable the particular container in response to the command, the instruction comprising an identifier specific to the specific container;
c) conditioning the instruction for wireless transmission and wirelessly transmitting the conditioned instruction to the containers; and
d) receiving the transmitted instruction and enabling or disabling the lock mechanism of the particular container if the instruction contains the identifier specific to that container.

30. The method as set forth in claim 29 wherein conserving the life of the battery comprises the steps of:
a) transmitting the instruction to enable or disable a particular container at a predetermined time;
b) activating the wireless receiver of the particular container approximately at the predetermined time to receive the instruction; and
c) deactivating the wireless receiver of the particular container after the instruction has been received whereby battery life is conserved.
